(19) United States
(12) Patent Application Publication
(10) Pub. No.: US 2026/0234355 A1
(43) Pub. Date: Aug. 13, 2026

(54) METHOD FOR UPCYCLING PLASTIC WASTE BY ENZYMATIC DEGRADATION AND PHOTOREFORMING

(71) Applicant: Cambridge Enterprise Limited, Cambridge (GB)

(72) Inventors: Chengzhi Guo, Cambridge (GB); Subhajit Bhattacharjee, Cambridge (GB); Erwin Reisner, Cambridge (GB); Florian Hollfelder, Cambridge (GB); Erwin Lam, Cambridge (GB); Taylor Uekert, Cambridge (GB)

(21) Appl. No.: 19/152,513

(22) PCT Filed: Jan. 31, 2024
(86) PCT No.: PCT/EP2024/052423

§ 371 Date: Jul. 31, 2025

(30) Foreign Application Priority Data
Feb. 1, 2023 (GB) 2301443.4

(51) Int. Cl. C08J 11/10; B01J 35/39; C01B 3/40

(52) U.S. Cl. CPC C08J 11/105; B01J 35/39; C01B 3/40; C01B 2203/0227; C08J 2367/02

(57) ABSTRACT

The present invention provides a method for upcycling plastic waste comprising: (i) contacting a plastic from said plastic waste with an enzyme to degrade said plastic to provide a composition comprising monomers and/or oligomers, and/or derivatives therefrom, of said plastic; and (ii) photoreforming said composition to produce a mixture of products comprising hydrogen gas and oxidation products of said monomers and/or oligomers, and/or derivatives therefrom.

### INTRODUCTION

The invention relates to the field of upcycling plastic waste to H₂ and chemicals, such as solar fuels. Specifically, the invention relates to a method of upcycling plastic waste using enzyme degradation and photoreforming. A system for upcycling plastic waste is also described.

### ACKNOWLEDGEMENTS

The project leading to this application has received funding from the European Research Council (ERC) under the European Union's Horizon 2020 research and innovation programme (grant agreement numbers 695669—PicoCB and 966581—SolReGen)

### BACKGROUND

Waste plastics are becoming a growing concern as environmental pollutants. Millions of tons of synthetic plastics are generated annually, and a mere 12% is recycled worldwide. This places significant pressure on landfill sites and represents a huge loss in chemical resources. Waste plastics also include micro- and nano-plastics that accumulate in soil and marine biomes. These are particularly challenging to recycle due to their low concentrations and small sizes.

A number of methods for recycling plastic are currently being researched. For example, Uekert et al, J. Am. Chem. Soc. 141, 15201-15210 (2019) and Bhattacharjee et al, Nat Synth (2023), DOI: 10.1038/s44160-022-00196-0 have shown that it is possible to photoreform poly(ethylene terephthalate) (PET) and poly(lactic acid) (PLA) to produce H₂ fuel and a variety of organic chemicals under alkaline aqueous conditions.

While these reports show the potential for waste plastic mitigation and fuel generation, a major drawback to the above-mentioned photoreforming technology is the harsh pretreatment conditions (corrosive alkaline media: pH>13; ~40-80° C.) required for the depolymerisation of plastics, the low conversion rates and the release of CO₂ from over-oxidation during photoreforming. These factors may prevent the scaling and commercial considerations of the current photoreforming technologies.

### SUMMARY OF INVENTION

In general, the present invention proposes a new methodology for upcycling plastic waste by using a combination of enzyme treatment and photoreforming. Specifically, it has been found to be possible to degrade plastic waste with an enzyme and then photoreform the degraded composition to produce a mixture of useful products. Advantageously, the method of the invention can be carried out in mild conditions (i.e. temperature, pH) compared to prior art methods, which facilitates scale up.

Accordingly, in a first aspect of the invention there is provided a method for upcycling plastic waste comprising:
(i) contacting a plastic from said plastic waste with an enzyme to degrade said plastic to provide a composition comprising monomers and/or oligomers, and/or derivatives therefrom, of said plastic; and
(ii) photoreforming said composition to produce a mixture of products comprising hydrogen gas and oxidation products of said monomers and/or oligomers, and/or derivatives therefrom.

Advantageously, the method allows for the generation of valuable products, including hydrogen, directly from waste plastics. The method shows a surprisingly high yield of hydrogen compared to prior art methods. Without wishing to be bound by theory, this is believed to arise from the enzyme degradation providing high quantities of oxidisable monomers and/or oligomers, and/or derivatives therefrom, that are effectively oxidised during the photoreforming. Further, the method has been shown to be effective for nano-plastics present at very low concentrations. It may therefore allow for finely distributed waste to be converted into valuable products.

Advantageously, the method is capable of operating under mild temperature and pH conditions, avoiding the necessity for harsh alkaline conditions employed in prior art methods. This may overcome the drawbacks associated with scaling-up prior art methods for commercial use. It may also provide benefits to the operational safety and operational efficiency of upcycling the plastic waste.

Advantageously, the use of enzymes also allows high selectivity. For example, enzymes may be tuned to the degradation of particular plastics or may be used to degrade plastics within solutions that contain other components.

Advantageously, it has also been shown possible to conduct the method within a single reactor. This may increase the operational efficiency compared to prior art methods. It is surprising that these biological and photocatalytic reactions are compatible and can occur concurrently.

A further benefit to the method described herein is that it allows for simultaneous reduction of CO₂. This may mitigate the CO₂ release issues described in relation to the prior art and may allow for the generation of a H₂/CO mixture, which may be used for syngas, a highly desirable chemical feedstock.

In a second aspect of the invention there is provided a method for upcycling plastic waste comprising:
(i) contacting a plastic from said plastic waste with an enzyme to degrade said plastic to provide a composition comprising monomers and/or oligomers, and/or derivatives therefrom of said plastic and CO₂;
(ii) photoreforming said composition to produce a mixture of products comprising hydrogen, CO and oxidation products of said monomers and/or oligomers, and/or derivatives therefrom.

Advantageously, the second aspect of the invention generates a mixture of H₂ and CO which may be used for syngas and the generation of further chemicals

In a third aspect of the invention there is provided a system for upcycling plastic waste comprising:
(i) a degradation reactor for contacting a plastic from said plastic waste with an enzyme to degrade said plastic to provide a composition comprising monomers and/or oligomers, and/or derivatives therefrom, of said plastic;
(ii) a photoreactor comprising a photocatalyst for photoreforming said composition to produce a mixture of products comprising hydrogen gas and oxidation products of said monomers and/or oligomers, and/or derivatives therefrom, and
(iii) a means for transporting the composition comprising monomers and/or oligomers, and/or derivatives therefrom, of said plastic to said photocatalyst and/or photoreactor for photoreforming.

Advantageously, the system of the third aspect of the invention provides a system for conducting the method according to the first and second aspects of the invention.

### Definitions

As used herein the term “upcycling” refers to the conversion of material regarded as waste to valuable, typically useable, material.

As used herein the term “plastic waste” refers to waste comprising one or more polymers and additives. Typically plastic waste is mixed, i.e. it comprises a mixture of different types or classes of polymers. Examples of plastic waste include used bottles, films, carrier bags, trays and other forms of packaging.

As used herein the term “plastic” refers to the polymer(s) present in plastic waste.

The term “photoreforming” is known in the art but for the avoidance of doubt refers to a process wherein a photocatalyst reduces H⁺ into hydrogen gas and oxidises organic compounds. In a typical photoreforming process, electron-hole pairs are generated by irradiating a photocatalyst with light, and the electron-hole pairs both reduce a first species, usually H⁺, and oxidise a second species.

As used herein the term “derivatives”, which is used in relation to monomers and oligomers, refers to a compound that is derived from monomers or oligomers, by a chemical conversion.

As used herein the term “photocatalyst” refers to a catalyst system capable of absorbing light to generate electron-hole pairs and provide said electrons and holes to the species being oxidised or reduced.

As used herein the term “photoactive material” refers to a material of the photocatalyst capable of absorbing light to generate the electron-hole pairs. The material may or may not also be responsible for provide the electron or hole to the species being oxidised or reduced.

As used herein the term “co-catalyst” refers to a material capable of utilising an electron or hole generated by a photoactive material, to oxide or reduce a species and facilitate the overall process.

As used herein the term “microparticle” refers to a particle having an average diameter of 0.1 to 100 microns. Typically particle size is determined by laser diffraction.

As used herein the term “nanoparticle” refers to a particle having an average diameter of 1 to 100 nm. Typically particle size is determined by laser diffraction.

### DETAILED DESCRIPTION OF THE INVENTION

Embodiments of the various aspects of the invention are described below. For the avoidance of doubt, it will be appreciated, where appropriate, that any embodiments as described herein in relation to one aspect of the present invention will also apply to the other aspects of the present invention.

The first aspect of the present invention relates to a method comprising
(i) contacting a plastic from plastic waste with an enzyme to degrade said plastic to provide a composition comprising monomers and/or oligomers, and/or derivatives therefrom, of said plastic; and
(ii) photoreforming said composition to produce a mixture of products comprising hydrogen gas and oxidation products of said monomers and/or oligomers, and/or derivatives therefrom.

### Plastic Waste

The plastic waste processed in the method of the present invention is preferably post consumer plastic waste. This is plastic waste produced by an end consumer. A typical example of post consumer plastic waste is packaging.

Typically plastic waste is collected from consumers along with glass, paper, and/or metal. In preferred methods of the invention, the plastic in the plastic waste is separated from glass, paper and metal prior to step (i) of the method herein. Preferably materials that might damage processing equipment (e.g. stones, wood etc) are also separated from the plastic. Thus a further preferred method of the invention comprises separating the plastic in the plastic waste from non-plastic contaminants prior to step (i) of the method herein.

In another preferred method of the invention, the plastic waste is washed (e.g. with water) prior to step (i) of the method. Separation of plastic and washing may be carried out simultaneously or sequentially. Conventional equipment and methods may be used.

In the method of the present invention the plastic from the plastic waste is preferably in the form of film, powder, pellets, fibers, micro-particles, nano-particles, or combinations thereof. Optionally the plastic from the plastic waste goes through protrusion or heating, and the resultant plastic is shredded, pelletised, or milled prior to step (i) of the method of the present invention. Again, conventional equipment may be used. In prior art methods, the plastic is often converted to fiber or powder form to increase the surface area of the plastic for degradation. However, the need for this additional processing step consumes energy.

One preferred form of plastic for use in the method of the present invention is film. As explained in the examples sections, the invention has been shown to be highly effective when using film despite the reduced surface area present compared to the powders or fibers used in the prior art. The ability to directly use films may remove the requirements for preliminary processing steps thereby increasing the efficiency of the process.

Another preferred form of plastic for use in the method of the present invention is micro- or nano-particles. Optionally, the micro- or nano-particles may be present in a solution or dispersion. An advantage of the method of the present invention is that solutions or dispersions having low concentrations of plastic, such as 5 mg of plastic per ml or less, or 1 mg of plastic per ml or less, still generate hydrogen and oxidation products. Often this cannot be achieved with prior art methods without removing the particles from their solution/dispersion or at least increasing their concentration, which is costly and time consuming.

In a preferred method of the present invention, the plastic that undergoes degradation is a condensation polymer. More preferably the plastic that undergoes degradation comprises polyester, and still more preferably the plastic that undergoes degradation consists of polyester. The polyester may be an aliphatic polyester or a semi-aromatic polyester. It is another benefit of the method of the present invention that polyesters may be processed since the majority of the commercial recycling operations focus on polyolefins.

Examples of suitable polyester include poly(ethylene terephthalate) (PET), poly(butylene terephthalate) (PBT), polyethylene naphthalene (PEN), polytrimethylene terephthalate (PTT), polycaprolactone (PCL), polylactic acid (PLA), polyhydroxybutyrate (PHB), polyglycolic acid (PGA), polyethylene adipate (PEA), or combinations thereof. One preferred polyester is poly(ethylene terephthalate) (PET). Another preferred polyester is polycaprolactone (PCL).

### Enzymes

The purpose of the enzyme is to degrade the plastic from the plastic waste into monomers and/or oligomers, and/or derivatives therefrom which can be oxidised during the photoreforming. Enzymes are particularly advantageous over the alkaline solutions used in the prior art because they can operate in benign pH and can be highly selective for particular polymer types. It is therefore possible to foresee that the method of the present invention could be used to upcycle polyester in mixed plastic from plastic waste, and another process used to upcycle another class of polymer.

It will be appreciated that the invention is not particularly limited by the form in which the enzyme is provided. For example, the invention is intended to cover the direct use of the enzymes, as well as enzymes provided in cell lysates, cell secretions, or microorganisms. In a preferred method of the invention an enzyme per se is used.

In preferred methods of the invention, the enzyme degrades the plastic by hydrolysis. In further preferred methods, the enzyme is provided in an aqueous solution, and more preferably an aqueous buffer solution. This enables the plastic to be readily mixed with the enzyme.

Preferably the buffer solution has a buffer salt concentration of 0-500 mM, and more preferably a concentration of 30-100 mM. Example buffers include carbonate or phosphate ion buffers.

Preferably the enzyme is selected from depolymerases, laccases, esterases, peroixdases, alkane hydroxylases, amidases, polyurethanases, peptidases, tannases, lignolytic enzymes, exopolysaccharide-degrading enzymes, and combinations thereof. Preferably the enzyme is an esterase. More preferably the enzyme is an esterase selected from cutinase, carboxylesterase, PETase and combinations thereof. Still more preferably the enzyme is a PETase or a cutinase.

Example enzymes that are suitable for use in the method of the present invention include enzymes selected from native sequences IsPETase (A0A0K8P6T7), Mono(2-hydroxyethyl) terephthalate hydrolase (A0A0K8P8E7), leaf-branch compost cutinase (LCC, G9BY57), Thermobifida fusca cutinase (TfCut, E5BBQ3_THEFU), Thermobifida fusca hydrolase (TfH, Q6A014), NyIA (NYLA_PSES8) and NyIB from strain NK87, Est1 from T.alba AHK119 (D4Q9N1); and their variants with sequence identity greater than 75%.

### Enzyme Degradation Step

In preferred methods of the invention, step (i) is carried out at a temperature of 25 to 100° C., such as 30 to 75° C. These relatively mild conditions are beneficial in that they are cheap to operate, and straight-forward to scale.

In further preferred methods of the invention, step (i) is carried out at pH 4-12, optionally at pH 6-8. As mentioned above, the use of milder pH conditions compared to prior art methods may present a significant advantage for scaling up and commercialising the method.

In preferred methods of the invention, step (i) is carried out for 4 hrs to 7 days. More preferably 12 to 48 hrs, and even more preferably about 24 hrs.

In some methods of the invention, the plastic is in an aqueous solution or a dispersion. In such methods the concentration of the plastic is preferably 0.1 to 100 mg per ml, more preferably 0.5 to 50 mg per ml and still more preferably 1 to 30 mg per ml. In some methods of the invention, the plastic is in an aqueous solution or dispersion with a concentration of 5 mg of plastic per ml or less, such as 1 mg of plastic per ml or less, or 0.5 mg of plastic per ml or less.

Preferably the aqueous solution is stirred or agitated during step (i). For example, the aqueous solution may be stirred at 30 to 1000 rpm.

In alternative embodiments, the plastic is in a semi-aqueous solution. The concentration of plastic in the semi-aqueous solution may be the same as that described above for an aqueous solution.

In preferred methods of the invention, the enzyme and the plastic are present in a weight ratio of 0.01 to 1.0% (weight_{enzyme}/weight_{plastic}). More preferably, the enzyme and the plastic are present in a weight ratio of 0.05 to 0.4%.

Composition Obtained from Degrading Plastic

In preferred methods of the invention, the composition obtained by degradation of the plastic comprises monomers and/or oligomers of the plastic. In some cases, derivatives of monomers and/or oligomers may be obtained. In preferred methods the composition obtained by degradation predominantly comprises monomers. This enables the composition undergoing oxidation to be understood. As shown in the examples, enzymes are effective at producing monomers from plastic and these monomers can be oxidised into useful organic compounds.

Examples of monomers include 6-hydroxyhexanoic acid, ethylene glycol, methyenedianiline, bis(2-hydroxyethyl) terephthalate (BHET), mono (2-hydroxyethyl) terephthalate (MHET), 4-hydroxybutanoic acid, terephthalic acid, 1,4-butanediol, naphthalene-2,6-dicarboxylic acid, 1,3-propanediol, lactic acid, 2-hydroxybutanoic acid, 3-hydroxylbutanoic acid, glycolic acid, adipic acid and/or derivatives thereof, and combinations thereof.

In some methods of the invention, the method comprises removing any solid residues from the composition comprising monomers and/or oligomers, and/or derivatives therefrom prior to step (ii). Solid residues may, for example, be removed by centrifugation of the composition.

In some methods of the invention, one or more of the degradation products of the plastic is removed from the composition. This may be advantageous if one of the products is found to interfere with the photoreforming reaction thereby reducing the yield of useful products generated.

In preferred methods of the invention, the composition further comprises CO₂. Optionally the CO₂ may be generated from the degradation of the plastic. Alternatively or additionally, the CO₂ may be added to the composition prior to step (ii). The CO₂ may be a waste material from another process. Addition of CO₂ may allow for the simultaneous reduction of CO₂ and the oxidation of the monomers/oligomers derived from the plastic thereby utilising two waste stocks to produce new chemical products.

### Photoreforming Step

In preferred methods of the invention, the composition which undergoes photoreforming in step (ii) is an aqueous solution. Advantageously aqueous solutions allow for hydrogen to be generated from reduction of water. Aqueous solutions are also desirable for maintaining enzyme activity.

In some further preferred methods of the invention, the composition comprising monomers and/or oligomers, and/or derivatives therefrom is used directly in step (ii). In other preferred methods, and as mentioned above, solids and/or specific compounds may optionally be removed. This is preferred if, for example, catalyst inhibition is likely to occur.

In the methods of the invention, the photoreforming may be carried out with UV light, visible light, or a combination of both. In some methods of the invention, photoreforming is carried out with visible light. In alternative methods, photoreforming is carried out using both UV and visible light. The light may be solar light or artificial light, (e.g. LED light). Solar light is particular advantageous because it allows for the photoreforming to directly utilise the energy from the Sun.

In some methods of the invention, photoreforming is carried out with light in the wavelength range 250 to 700 nm, and more preferably with light in the wavelength range 400 to 700 nm.

In preferred methods of the invention, photoreforming is carried out with a photocatalyst comprising a photoactive material selected from metal oxide, a chalcogenide, a nitride, a carbon-based photosensitiser, dyes, nanoparticles (such as quantum dots), a pervoskite, a metal-organic framework, a covalent-organic framework or a co-ordination polymer, or combinations thereof. Examples of suitable photoactive materials include TiO₂, SrTiO₃, Fe₂O₃, SnO₂, ZrO₂, W₃, ZnO, CdS, CdSe, ZnS, ZnSe, CdTe, MoS₂ GaN, InN, carbon-nitride, carbon dots, graphene, molecular dyes, CsPbCl₃, CsPbBr₃, CsPbI₃, Cs₃Bi₂Cl₉, Cs₃Bi₂Br₉, or Cs₃Bi₂I₉, or combinations thereof.

In preferred methods of the invention, photoreforming is carried out with a photocatalyst comprising both a photoactive material and a co-catalyst. Preferably, the co-catalyst comprises a transition element. Preferably, the co-catalyst comprises Pt, Pd, Ru, Ni, Co, Fe, Mn, Cu, Zn or combinations thereof.

Examples of suitable co-catalysts comprise Pt, Ni₂P, hydrogenase, phosphonated Re complexes, [Re(2,2′-bipyridine-4,4′-bisphosphonic acid)(CO)₃(L)] where L=3-picoline or bromide, carbon monoxide dehydrogenase, and formate dehydrogenase.

In preferred methods of the invention, the co-catalyst is capable of reducing carbon dioxide. An example of a co-catalyst that is capable of reducing carbon dioxide is cobalt bis(terpyridine) (CotpyP).

In some preferred methods of the invention, the co-catalyst is capable of reducing water to produce hydrogen.

In preferred methods of the invention, the photoreforming is carried out with an immobilised catalyst.

In preferred methods of the invention, the photoreforming is conducted at a pH of 6 to 8.

In preferred methods of the invention, the photoreforming is conducted at a temperature between 15 and 50° C.

In preferred methods of the invention, the photoreforming is conducted for 2 to 96 hours.

Preferably the oxidation products of said monomers and/or oligomers, and/or derivatives therefrom, are selected from alcohols, aldehydes, ketones, amines, organic acids, carbon dioxide, derivatives therefrom, or combinations thereof. For example, the oxidation products of said monomers and/or oligomers, and/or derivatives therefrom, may be are selected from formic acid, glycolic acid, oxalic acid, acetic acid, glyoxal, glycolaldehyde, pentanal, hexanal, butanal, propanal, ethanal, carbon dioxide, derivatives therefrom, and/or combinations thereof.

In some methods of the invention, one or more of the oxidation products of the monomers and/or oligomers, and/or derivatives therefrom, is removed from the composition. This may be advantageous if one of the oxidation species is found to interfere with the photoreforming reaction thereby reducing the yield of useful products generated.

### Advantageous Combinations

In a particularly preferred method of the invention, the plastic comprises poly(ethylene terephthalate) (PET), the enzyme comprises a PETase, the photocatalyst comprises a photoactive material selected from a metal oxide and a nitride, and the photocatalyst further comprises a co-catalyst selected from a Pt, Pd, Ru, Ni, Co, Fe, Mn, Cu, Zn or combinations thereof.

In another particularly preferred method of the invention, the plastic comprises polycaprolactone (PCL), the enzyme comprises a cutinase, the photocatalyst comprises a photoactive material selected from a metal oxide and a nitride, and the photocatalyst further comprises a co-catalyst selected from a Pt, Pd, Ru, Ni, Co, Fe, Mn, Cu, Zn or combinations thereof.

In another particularly preferred method of the invention, the plastic comprises poly(ethylene terephthalate) (PET) or polycaprolactone (PCL), the enzyme comprises a PETase or cutinase, the photocatalyst comprises a photoactive material selected from a metal oxide and a nitride, and the photocatalyst further comprises a co-catalyst capable of reducing CO₂.

In the methods of the present invention, steps (i) and (ii) may be carried out separately or may be carried out concurrently. When carried out concurrently, the steps are preferably carried out in a single reactor. Conducting the steps in a single reactor may increase the operational efficiency compared to prior art methods and it is surprising that these biological and photocatalytic reactions are compatible and can occur concurrently.

### System

The present invention also relates to a system for upcycling plastic waste comprising:
(i) a degradation reactor for contacting a plastic from said plastic waste with an enzyme to degrade said plastic to provide a composition comprising monomers and/or oligomers, and/or derivatives therefrom, of said plastic;
(ii) a photoreactor comprising a photocatalyst for photoreforming said composition to produce a mixture of products comprising hydrogen gas and oxidation products of said monomers and/or oligomers, and/or derivatives therefrom, and
(iii) a means for transporting the composition comprising monomers and/or oligomers, and/or derivatives therefrom, of said plastic to said photocataylst and/or said photoreactor for photoreforming.

Preferably the system comprises a means for capturing hydrogen.

Preferably the system comprises a means for collecting oxidation products.

Preferred systems may comprise a light source. Optionally this can be provided separately.

Preferably the system comprises an immobilised photocatalyst (e.g. a photocatalyst immobilised on a panel contained in the photoreactor).

A preferred system of the present invention is integrated. In a preferred integrated system, the degradation reactor is contained inside the photoreactor. Particularly preferably the photoreactor contains an immobilised photocatalyst (e.g. a photocatalyst immobilised on a panel contained in the photoreactor). In this case the means for transporting the composition comprising monomers and/or oligomers, and/or derivatives therefrom, of the plastic to the photocataylst and/or the photoreactor for photoreforming is preferably the reaction medium (e.g. water) in which degradation occurs.

Thus a preferred system according to the invention comprises:
(i) a degradation reactor for contacting a plastic from said plastic waste with an enzyme in a reaction medium to degrade said plastic to provide a composition comprising monomers and/or oligomers, and/or derivatives therefrom, of said plastic;
(ii) a photoreactor comprising a photocatalyst for photoreforming said composition to produce a mixture of products comprising hydrogen gas and oxidation products of said monomers and/or oligomers, and/or derivatives therefrom, wherein said degradation reactor is contained inside said photoreactor; and
(iii) a means for transporting the composition comprising monomers and/or oligomers, and/or derivatives therefrom, of said plastic to said photocatalyst and/or the photoreactor for photoreforming is the reaction medium in which degradation occurs.

Put another way, a preferred system comprises a unitary photoreactor for upcycling plastic waste, the reactor comprising:
(i) a reaction medium comprising an enzyme for degrading said plastic to provide a composition comprising monomers and/or oligomers, and/or derivatives therefrom, of said plastic; and
(ii) a photocataylst for photoreforming said composition to produce a mixture of products comprising hydrogen gas and oxidation products of said monomers and/or oligomers, and/or derivatives therefrom,
wherein the reaction medium is capable of transporting the monomers and/or oligomers, and/or derivatives therefrom to the photocataylst.

The invention will now be described by the following non-limiting examples.

### EXAMPLES

The materials used in the examples were all commercially available, unless otherwise stated.

### DuraPETase Expression and Purification

The DuraPETase gene, with a C-terminal Strep-tag, was obtained as a synthetic gene (ThermoFischer) before cloning into the E. coli expression vector pHAT5 with restriction enzymes (ThermoFischer FastDigest) NcoI and XhoI. For the expression and purification of DuraPETase single colonies from E. coli OverExpress™ C41 (DE3) (Lucigen) transformations were grown in MDAG-135 non-inducing media supplemented with 50 μg mL⁻¹ carbenicillin (37° C.; 200 rpm shaking; 24 h) as a starter culture. ZYM-5052 media was inoculated with the starter culture (1:100 v/v inoculation ratio) and incubated at 20° C. with 300 rpm shaking until growth saturation was reached for overexpression.

Cells were pelleted by centrifugation at 4000×g for 10 min at 4° C. and resuspended in Buffer W (100 mM Tris (pH 8.0), 150 mM NaCl) before homogenization using Emulsiflex C5. The lysate was cleared by centrifugation at 20000×g for 30 minutes and passed through a Strep-Tactin (IBA) gravity column. The purified DuraPETase was buffer exchanged into carbonate buffer (27 mM Na₂CO₃, 90 mM NaHCO₃ (pH 8.5), 100 mM NaCl) using PD-10 desalting columns (GE Healthcare) and stored at 4° C. for up to 4 days.

### LCC Expression and Purification

The LCC gene was cloned in pExp-Bla plasmid and transformed into Shuffled T7 express cells (New England BioLabs, catalogue number C3029J). The cells were grown at 37° C. in 1 L of LB media containing 100 μg mL-1 ampicillin until the OD600 nm reached 0.5 to 0.6. The expression of the recombinant protein was induced by adding 0.4 mM of IPTG at 20° C. for 20 h. Cells were harvested by centrifugation at 3434 g for 20 min and resuspended in 20 mL of 50 mM Tris-HCl pH 8.0 and lysed via Emulsiflex (Avestin). To the extract was added NaCl, imidazole and β-mercaptoethanol for a final concentration of 250 mM, 10 mM and 10 mM, respectively. After lysis, cells were centrifuged at 11,000 g for 45 min at 4° C. to remove cell debris and the supernatant was loaded onto a nickel affinity resin (catalogue number Super-NiNTA25, Protein Ark), previously equilibrated with buffer [50 mM Tris-HCl pH 8.0, 250 mM NaCl, 10 mM imidazole and 5% (v/v) glycerol]. The purification was performed in a stepwise imidazole gradient and the purification fractions analyzed in an SDS-PAGE gel. The fractions containing purified LCC-pExp-Bla recombinant protein were selected for concentration with Amicon Ultra-15 filters (Merck-Millipore, catalogue number UFC901024). To the concentrated material was added buffer containing 50 mM Tris-HCl pH 8.0, 100 mM NaCl, 2.5% (v/v) glycerol, and the material was submitted to another concentration step. This concentration and dilution step was repeated three times in order to remove the imidazole. To the final concentrated material was added 0.1 mg of TEV protease for cleavage overnight and the material was submitted to a centrifugation at 11,000 g for 15 min at 4° C. to remove any precipitated protein. The supernatant loaded into a column containing a resin previously equilibrated with buffer containing 100 mM NaCl, 100 mM bicarbonate pH 8.0 for a second purification step via IMAC.

### Preparation of PCL Films

PCL films were generated by dissolving 200 mg of PCL flakes (average Mw~14,000, average Mn ~10,000 by GPC) in 10 mL dichloromethane. 500 μL or 1 mL of the solution were evaporated in an open 1.5 mL tube at 86° C. The average dimensions of the films used in the experiments was πrl (cone lateral surface) 5.34 cm³.

### Preparation of PET Films

PET films were used directly as purchased from Goodfellow. The average dimensions of the films used in the experiments was 2 cm³. The polymer was bilaxially oriented with a crystallinity of 6-8%.

### Preparation of PET and PCL Nanoparticles

Plastic nanoparticles were prepared following a precipitation and solvent evaporation technique. 50 mg amorphous PET film (product code ES303015, Goodfellow GmbH, London, UK) or PCL flakes were dissolved in 1,1,3,3,3,-hexafluoro-2-propanol (5 mL) for at least one hour. This solution was added dropwise (1 mL/min) to purified (MilliQ®) water (50 mL, cooled in an ice bath). At the same time the water was rigorously stirred using an Ultra Turrax® stirrer at 8000 rpm (IKA, Germany). The suspension was filtered using Whatman filter paper (8 μm diameter) and the remaining solvent was evaporated. Particle sizes of d=131.7 nm for PET and d=184.9 nm for PCL were obtained using dynamic light scattering (Zetasizer Nano S).

### Enzymatic Treatment of Plastic Materials

### Enzyme Treatment 1 (Dura)

A Dura enzyme stock solution was prepared as described above and spun at 14,000×g (4° C.) for 10 min to eliminate protein precipitation. The protein concentration in the supernatant was determined by measuring absorbance at 280 nm using Nanodrop ND-1000 spectrophotometer (Nanodrop Technologies). The supernatant was diluted to a concentration of 1 μM with carbonate buffer (27 mM Na₂CO₃, 90 mM NaHCO₃ (pH 8.5), 100 mM NaCl) and 1 mL of diluted enzyme solution was incubated with either PCL or PET (films or nanoplastics) for 2 days. The incubation temperature was 37° C. Prior to the photocatalysis experiments, the solutions were centrifuged at 20000×g for 10 min to remove any solid residues from the solution.

### Enzyme Treatment 2 (LCC)

A LCC enzyme stock solution was prepared as described above and spun at 14,000×g (4° C.) for 10 min to eliminate protein precipitation. The protein concentration in the supernatant was determined by measuring absorbance at 280 nm using Nanodrop ND-1000 spectrophotometer (Nanodrop Technologies). The supernatant was diluted to a concentration of 1 μM with carbonate buffer (27 mM Na₂CO₃, 90 mM NaHCO₃ (pH 8.5), 100 mM NaCl) and 1 mL of diluted enzyme solution was incubated with either PCL or PET (films or nanoplastics) for 2 days. The incubation temperature was 65° C. Prior to the photocatalysis experiments, the solutions were centrifuged at 20000×g for 10 min to remove any solid residues from the solution.

Quantification of the products after enzymatic treatment was conducted using reverse-phase high-performance liquid chromatography (HPLC).

### Synthesis of Photocatalysts/Co-Catalysts

A TiO₂|Pt photocatalyst was prepared by solution-processed platinization of P25 TiO2 nanoparticles (Evonik, anatase/rutile, 21 nm). 150 mg of TiO2 was dispersed in 10 mL of purified (MilliQ®) water through bath sonication for 30 min. Thereafter, 0.29 g of trisodium citrate dihydrate was added to the dispersion followed by sonication for another 30 min. 42 μL of H₂PtCl₆ solution (8% in water) was then added to the mixture. After sonication for further 20 min, freshly prepared NaBH4 solution (5 mg dissolved in 1 mL of MilliQ® water) was added to the solution drop-wise under stirring. After stirring for 30 min, the TiO₂|Pt photocatalyst was isolated using centrifugation, washed with water and dried at 80° C. overnight under air.

A CNₓ|Ni₂P photocatalyst was prepared as follows. CNₓ refers to a polymeric carbon-nitride material. It will be appreciated that carbon-nitrides are typically materials which have a general simplified ratio of C₃N₄. An unfunctionalised polymeric carbon-nitride (CNₓ) was first prepared by heating 2 g of melamine to 550° C. under air for 4 h (ramping rate 5° C. min⁻¹) in a covered crucible. 300 mg of the as-prepared CNₓ was then mixed with NiCl₂·6H₂O (20 mg for 2 wt. %) in minimum volume of MilliQ® water (1 mL), followed by stirring and sonication for 1 h each. NaH₂PO₂·H₂O was then added to the reaction mixture and again stirred for 1 h, followed by bath sonication for another 1 h. The mixture was dried in-vacuo at 60° C. and the dry solid obtained was heated at 200° C. for 1 h under Ar atmosphere (ramping rate 5° min⁻¹). The CNₓ|Ni₂P powder obtained after cooling to room temperature was washed with ethanol and water and dried in-vacuo at 60° C.

TiO₂|CotpyP catalyst was synthesized according to the protocols reported in Leung, J. J. et al. Solar-driven reduction of aqueous CO₂ with a cobalt bis(terpyridine)-based photocathode. Nat Catal 2, 354-365, doi:10.1038/s41929-019-0254-2 (2019) and E. Lam, E. Reisner, Angew. Chem. Int. Ed. 2021, 60, 23306, followed by immobilization with TiO2 during photocatalysis.

The loadings of the co-catalyst on the photocatcalyst (TiO₂ or CNₓ) were determined using inductively coupled plasma optical emission spectrometry (ICP-OES).

### Photoreforming Catalysis on Enzyme Treated Plastics

2 mg of the photocatalyst powder (TiO₂|Pt or CNₓ|Ni₂P) was added to 1 mL of the enzyme pre-treated plastic solution (pH ~6-8) in Pyrex glass photoreactor vials (internal volume: 7.91 mL) and sealed with a rubber septum. The photocatalyst was dispersed via bath sonication for 25 min. Thereafter, the samples were purged with N₂ (with 2% CH₄ as an internal standard and leakage control during gas analysis) for another 25 min. The samples were then irradiated using a solar light simulator (Newport Oriel) calibrated to 100 mW cm⁻² (1 Sun) and equipped with an air mass 1.5 global (AM 1.5 G) filter and a water filter to remove infrared radiation. The temperature was maintained at 25° C. and the samples were stirred at 600 rpm during irradiation.

### Integrated Enzyme Treatment and Photoreforming Catalysis

TiO₂|Pt photocatalyst panels were initially prepared. Frosted glass panels (4.5×4.5 cm²) were cleaned by sonication in purified (MilliQ®) water, isopropanol and acetone, 15 min in each, respectively and then dried under N₂ flow. The TiO₂|Pt photocatalyst was dispersed in ethanol (20 mg mL⁻¹) by probe-sonication (10 min, pulses of 30 s at 100% amplitude followed by 5 s pauses) followed by the addition of 1 vol. % Nafion™ solution (5 wt. %) to the resultant mixture. The dispersion was carefully drop-casted onto clean frosted glass (total of 16 μL cm⁻² at a time) and dried for 10 min before the addition of subsequent layers (a total of 6 layers were added; final catalyst loading of ~1.92 mgcat cm⁻²). The prepared TiO₂|Pt panels were then annealed at 80° C. overnight in air.

The TiO₂|Pt photocatalyst panels (effective area 3.5×3.5 cm²) were mounted on a custom-made, air-tight PEEK reactor equipped with a quartz window. 12 mL of the carbonate buffer with LCC enzyme (concentration: 1 μM) and a piece of transparent PET film (weight ~240 mg) was added to the reactor and then properly sealed. The solution was purged with N₂ (with 2% CH₄ as an internal standard) and the reactor was then placed in a calibrated Newport Oriel solar simulator (AM 1.5G, 100 mW cm⁻²). The steady-state temperature inside the reactor was measured to be ~33° C. and the solution was not stirred during the experiment. Aliquots of the solution were taken at regular time intervals for estimating the hydrolysis of PET using HPLC-UV and the gas from the headspace (50 μL) was analyzed for H₂ evolution using GC (discussed below). A control experiment was carried out in pure blank buffer.

### Photoreforming of Enzyme Treated PET for CO2 Reduction

Enzyme pretreatment 2 (LCC) was conducted on a PET film. Experiments were then conducted either directly with the enzyme pre-treated solution or after the TPA was removed from the LCC pretreated PET solution. To remove the TPA, the solution was acidified with 1 M HCl to a pH of 3 which led to the precipitation of TPA as a white precipitate. The suspension was subsequently filtered using a syringe filter (0.2 mm) to obtain a clear solution. The clear solution was then subsequently neutralised with 1 M NaOH to the original pH of 6.5.

In a glass photoreactor, 5 mg TiO2 was suspended in 1 mL of the aqueous enzyme treated PET solution before or after TPA precipitation (see above) followed by 2 mL of MeCN. A known amount (25 or 50 nmol) of the molecular catalyst CotpyP (from a freshly prepared 2 mM solution in H₂O; 0.0125 mL for 25 nmol or 0.025 mL for 50 nmol CotpyP) was added while stirring. The photoreactor (~3 mL solution) was capped with a rubber septum and purged with CO₂ containing 2% CH₄ as an internal gas chromatography standard for 15 min, followed by stirring for 15 min in the dark. The photoreactor (kept at 25° C. and stirred at 600 rpm) was then irradiated with simulated solar irradiation (AM 1.5G, 100 mW cm⁻²) equipped with a water filter to remove infrared radiation. The photocatalytic process was monitored periodically by sampling the headspace (typically after 24 and 48 h) by GC to monitor H₂ and CO formation. Products in the solution (formate) was detected by ¹H NMR spectroscopy in D₂O (1:1 v:v photocatalysis solution:D₂O). The turnover numbers (TON) were calculated based on CotpyP assuming that all cobalt sites are active catalytic sites.

### Product Detection and Quantification

The production of H₂ and/or CO was detected and estimated by manual injection of gas from the reactor headspace (50 μL) into a Shimadzu GC-2010 Plus GC and quantified using CH₄ as an internal standard. The oxidation products in the solution post-photoreforming catalysis were detected and quantified using ¹H nuclear magnetic resonance spectroscopy (¹H-NMR) using maleic acid as an internal standard. The CO₂ and hydrocarbons were detected using an Agilent 7890A GC equipped with a flame ionization detector (FID) and thermal conductivity detector (TCD).

The measurements are represented as yield of gas (H₂ or CO) per weight of the substrate (μmol g_{sub}⁻¹) and activity per weight of the photocatalyst per hour (μmol g_{cat}⁻¹ h⁻¹). For the experiments with the integrated system, the H₂ evolution data is represented in terms of the aerial efficiency of the photocatalyst panel, (μmol mᵢᵣᵣ⁻²).

Unless otherwise indicated, the analytical measurements were performed in triplicates and represented as the unweighted mean±standard deviation.

The oxidation products were analysed using ¹H NMR spectroscopy or Gas chromatography.

### Results

### Treatment of PCL and PET Substrates

Typical results from the enzyme treatment of PCL and PET polymer substrates are shown in table 1 along with comparative alkaline treatment (2M NaOH). The molar yield of the monomers are provided after 2 hours, 4 hours, 1 day, 2 days and 7 days. The monomers detected were 6-hydroxyhexanoic acid (HA) for PCL and terephatlic acid (TPA) for PET.

Compared to alkaline treatment at identical incubation conditions, higher monomer yields were observed for enzymatic treatment on both polyesters. Moreover, plastics of different sizes were observed to be susceptible to enzymatic treatment. Both LCC and Dura exhibit degradation activity on PET and PCL nanoplastics (130-185 nm) with an increase in molar yield to a substrate-mass ratio of ~4-fold for PET and ~8-fold for PCL after a 2-day incubation compared to those with films.

TABLE 1

| | | | Molar Yield [HA or TPA] ± σ | | | | |
|---|---|---|---|---|---|---|---|
| | Treatment | Temp. | (μmol g_{sub}⁻¹) | | | | |
| Substrate | method | (° C.) | 2 h | 4 h | Day 1 | Day 2 | Day 7 |
| PCL film | Pretreatment 1 | 37 | 3.6 ± | 7.9 ± | 44.9 ± | 56.1 ± | 57.6 ± |
| (24.7 mg | (Dura) | | 0.2 | 0.5 | 0.9 | 2.0 | 1.7 |
| mL⁻¹) | Pretreatment 2 | 65 | n.m | n.m. | 4.8 ± | 4.7 ± | 6.0 ± |
| | (LCC) | | | | 0.1 | 0.1 | 0.2 |
| | 2M NaOH | 37 | n.m. | n.m. | n.q. | n.q. | n.q. |
| PET film | Pretreatment 1 | 37 | 0.01 ± | 0.01 ± | 0.1 ± | 2.04 ± | 38.2 ± |
| (20 mg | (Dura) | | 0.0 | 0.0 | 0.01 | 0.7 | 8.1 |
| mL⁻¹) | Pretreatment 2 | 65 | 3.6 ± | 24.7 ± | 575 ± | 1120.0 ± | 1260 ± |
| | (LCC) | | 1.9 | 9.1 | 57 | 53 | 170 |
| | 2M NaOH | 65 | n.m | n.m. | 2.7 ± | 4.8 ± | 8.4 ± |
| | | | | | 0.3 | 1.1 | 0.3 |
| PCL | Pretreatment 1 | 37 | n.m. | n.m. | 379 ± | 403 ± | 466 ± |
| nanoplastics | (Dura) | | | | 3.7 | 7.4 | 6.4 |
| (~0.1 mg | | | | | | | |
| mL⁻¹) | | | | | | | |
| PET | Pretreatment 2 | 65 | n.m. | n.m. | 3240 ± | 4320 ± | 5390 ± |
| nanoplastics | (LCC) | | | | 550 | 550 | 530 |
| (~0.1 mg | | | | | | | |
| mL⁻¹) | | | | | | | |

Table 2 shows results using the method of the present invention, showing the production of H₂ from PCL and PET polymers after enzymatic degradation. It also includes some comparative data (C₁-C₄) for photoreforming catalysis conducted on solutions obtained from degradation of PET polymers using alkaline solution. As can be seen, the results using an enzyme treated solution showed surprisingly high yields of H₂ compared to the prior art methods that utilised the well-known alkaline conditions to degrade the plastic materials. While C3 shows a relatively high yield of H₂ (comparable with example 6 of the invention that also employs a TiO₂|Pt photocatalyst), C3 used the photocatalyst at a significantly higher concentration and utilised a significantly higher loading of Pt, both of which would have been expected to provide improved performance. The example also employed harsh pre-treatment conditions (10 M NaOH). Moreover, comparing the catalyst activity for examples 6 and C3, it can be seen that a significant increase in performance is obtained using the enzymatic pre-treatment compared to the alkaline pre-treatment (518 umol g-cat⁻¹ h⁻¹ vs. 153 umol g-cat⁻¹ h⁻¹ respectfully). It is unexpected that this higher hydrogen production activity can be achieved without the harsh pre-treatment conditions. Further, all the comparative examples utilised PET powder (C1-C3) or microfibers (C4) which have significantly higher surface area compared to the PET films used in the examples of the present invention, and therefore the comparative methods would have been expected to show higher activity than the examples of the invention. In addition, the microfibers exhibited a lower crystallinity (<3%) compared to the PET film used in the examples of the invention (≈6%) and alkaline hydrolysis has been reported to be more efficient on low crystalline polymers (Polymers 2020, 12(10), 2195; Polym. Sci., 51: 99-109; Biomaterials, 16, 11, 1995, 833-843).

For the PET films (examples 5 & 6), the use of the LCC enzyme (enzyme treatment 2) in combination with the photoreforming was observed to result in particularly high H₂ yields. The major oxidation product identified for these experiments was formate. Without wishing to be bound by theory, the high H₂ yield is believed to be due to the efficacy of the enzyme towards PET hydrolysis (at 65° C.), which yielded a high concentration of monomers (EG/TPA) for subsequent oxidation. Table 3 also compares example 6 to three control experiments, C5, C6 and C7. C5 and C6 show that without the polymer or the enzyme, very little H₂ is evolved. C7 meanwhile shows the relevance of the co-catalyst. In addition, in further control experiments conducted without any photocatalyst or without any light no H₂ production was observed.

The highest yields for PCL films were observed from photoreforming catalysis after treatment with the Dura enzyme (enzyme treatment 1). As can be seen, the major oxidation products identified were pentanal and CO₂ with traces of formate and hydrocarbons. Without wishing to be bound by theory, the ~1:1 ratio of pentanal:CO2 observed may be due the 6-hydroxyhexanoic acid formed from the enzymatic treatment of PCL films undergoing a 2e⁻ oxidation utilizing the photo-generated holes to form 6-oxohexanoic acid (OA). Thereafter, decarboxylation of OA yields CO₂ and pentanal in equimolar ratios.

The use of TiO₂|Pt photocatalyst resulted in increased yields over the CNₓ|Ni₂P photocatalyst. However, CNₓ|Ni₂P has the ability to absorb in the visible region, and is precious-metal free, as opposed to TiO₂|Pt, which absorbs primarily in the UV region.

Examples 7-13, show results using solutions of enzyme degraded nanoplastic substrates. The concentration of the nanoplastics used for the treatment was ~0.1 mg mL⁻¹. It is surprising that hydrogen production can be observed using such low concentrations. The H₂ yields and activities follow a similar trend as in the case of the PET and PCL films. The substrate-normalised H₂ yields of the nanoplastics are considerably higher due to the low initial plastic concentrations, with respect to which the amount of H₂ produced.

Table 4 shows the results from simultaneous H₂O (H⁺) and CO₂ reduction experiments to generate syngas. CotpyP was used as a co-catalyst, which is a Co²⁺-based molecular CO₂ reduction catalyst coordinated by two terpyridine ligands bearing phosphonate groups for anchoring onto TiO₂. Example 14 shows the production of both CO and H₂ using TiO₂|CotpyP in combination with enzyme treatment of a PET film. Examples 15 and 16 show that the syngas yield can be increased by removing the TPA monomers prior to the photocatalysis. Without wishing the be bound by theory, this is believed to arise due to the TPA inhibiting the cobalt catalyst.

Table 5 shows the results from an integrated enzyme treatment and photoreforming catalysis experiment for production of H₂ directly from PET films. Data is provided at intervals up to 96 hours. A TiO₂|Pt photocatalyst was used in the reactor with an LCC enzyme.

It was observed that with increasing enzyme-mediated hydrolysis of the PET film, the amount of H₂ production also increased. A change in the texture and transparency of the PET film was also observed after the experiment. Without wishing to be bound by theory, this is believed to arise due to enzymatic attack on the film. This suggests that the enzymes are active under the given conditions producing monomers of ethylene glycol (EG) and terephtalic acid (TPA) through PET hydrolysis. The EG formed from the PET can be oxidised by the panel in-situ to produce organics, with the simultaneous generation of H₂ from the solution. ¹H-NMR spectroscopy of the solution after 96 h of photoreforming confirmed the presence of formate as the EG oxidation product. Control experiments with blank buffer solutions in the absence of plastics showed negligible H₂ production after 96 h. This demonstration confirms the applicability of combining the photoreforming system with the enzyme treatment to generate H₂ in a single chamber.

TABLE 2

| | | | | | | | | Activity | | |
|---|---|---|---|---|---|---|---|---|---|---|
| | | Pre- | | | | | Yield | (μmol | Oxidation | |
| | | treatment | Photo- | | Irradi- | n[H₂] | (μmol | g_{cat}⁻¹ | products | n[OP] |
| No. | Substrate | conditions | catalyst | Media | ation | (μmol) | g_{sub}⁻¹) | h⁻¹) | (OP) | (μmol) |
| 1 | PCL film | Enzyme | TiO₂\|Pt- | Carbonate | AM 1.5 G | 26.5 ± | 1070 ± | 553 ± | pentanal, | 4.8 ± |
| | (24.7 mg | treatment 1 | 1 wt % | buffer | 24 h | 2.1 | 85 | 44 | formate, | 0.4, |
| | mL⁻¹) | (Dura) | (2 mg | (pH 6) | | | | | CO₂, | 0.5 ± |
| | | | mL⁻¹) | | | | | | hydro- | 0.1, |
| | | | | | | | | | carbons | 5.1 ± |
| | | | | | | | | | | 0.6, |
| | | | | | | | | | | traces, |
| | | | | | | | | | | resp. |
| 2 | PCL film | Enzyme | TiO₂\|Pt- | Carbonate | AM 1.5 G | 20.1 ± | 812 ± | 418 ± | pentanal, | 2.5 ± |
| | (24.7 mg | treatment 2 | 1 wt % | buffer | 24 h | 1.4 | 56 | 29 | formate, | 0.2, |
| | mL⁻¹) | (LCC) | (2 mg | (pH 6) | | | | | CO₂, | 0.5 ± |
| | | | mL⁻¹) | | | | | | hydro- | 0.05, |
| | | | | | | | | | carbons | 2.6 ± |
| | | | | | | | | | | 0.4, |
| | | | | | | | | | | traces, |
| | | | | | | | | | | resp. |
| 3 | PCL film | Enzyme | CNₓ\|Ni₂P- | Carbonate | AM 1.5 G | 0.8 ± | 32.1 ± | 16.5 ± | pentanal, | 0.6 ± |
| | (24.7 mg | treatment 1 | 2 wt % | buffer | 24 h | 0.1 | 3.8 | 2.0 | formate, | 0.4, |
| | mL⁻¹) | (Dura) | (2 mg | (pH 6) | | | | | CO₂, | <0.1, n.q., |
| | | | mL⁻¹) | | | | | | hydro- | n.q., resp. |
| | | | | | | | | | carbons | |
| 4 | PCL film | Enzyme | CNₓ\|Ni₂P- | Carbonate | AM 1.5 G | 0.6 ± | 22.4 ± | 11.5 ± | pentanal, | 0.2 ± |
| | (24.7 mg | treatment 2 | 2 wt % | buffer | 24 h | 0.2 | 7.4 | 3.8 | formate, | 0.05, |
| | mL⁻¹) | (LCC) | (2 mg | (pH 6) | | | | | CO₂, | <0.1, n.q., |
| | | | mL⁻¹) | | | | | | hydro- | n.q., resp. |
| | | | | | | | | | carbons | |
| 5 | PET film | Enzyme | TiO₂\|Pt- | Carbonate | AM 1.5 G | 1.3 ± | 66.1 ± | 27.5 ± | n.q | n.q. |
| | (20 mg | treatment 1 | 1 wt % | buffer | 24 h | 0.3 | 16.6 | 6.9 | | |
| | mL⁻¹) | (Dura) | (2 mg | (pH 6) | | | | | | |
| | | | mL⁻¹) | | | | | | | |
| 6 | PET film | Enzyme | TiO₂\|Pt- | Carbonate | AM 1.5 G | 24.8 ± | 1240 ± | 518 ± | formate, | 3.3 ± |
| | (20 mg | treatment 2 | 1 wt % | buffer | 24 h | 0.6 | 31 | 13 | glycolate, | 0.2, |
| | mL⁻¹) | (LCC) | (2 mg | (pH 6) | | | | | oxalate | n.q., n.q., |
| | | | mL⁻¹) | | | | | | | resp. |
| C1 | PET | Strong | CNₓ\|Ni₂P- | 1M aq. | AM 1.5 G | — | 34.4 | 26.8 | acetate, | n.m |
| | powder | alkaline | 2 wt % | KOH | 20 h | | | | formate, | |
| | (25 mg | (2M KOH, | (1.6 mg | | | | | | glycolate, | |
| | mL⁻¹) | 40° C.), | mL⁻¹) | | | | | | glyoxal | |
| | | with | | | | | | | | |
| | | stirring | | | | | | | | |
| C2 | PET | Strong | TiO₂\|Ni₂P | 1M aq. | AM 1.5 G | — | 13.8 | 10.8 | acetate, | n.m. |
| | powder | alkaline | 2 wt % | KOH | 20 h | | | | formate, | |
| | (25 mg | (2M KOH, | (2 mg | | | | | | glycolate, | |
| | mL⁻¹) | 40° C.), | mL⁻¹) | | | | | | glyoxal | |
| | | with | | | | | | | | |
| | | stirring | | | | | | | | |
| C3 | PET | Strong | TiO₂\|Pt- | 10M aq. | AM 1.5 G | — | 1220 | 153 | n.m. | n.m. |
| | powder | alkaline | 5 wt % | NaOH | 20 h | | | | | |
| | (25 mg | (10M NaOH, | (10 mg | | | | | | | |
| | mL⁻¹) | 40° C.), | mL⁻¹) | | | | | | | |
| | | with | | | | | | | | |
| | | stirring | | | | | | | | |
| C4 | PET | Strong | ^{NCN}CNₓ\|Ni₂P- | 1M aq. | AM 1.5 G | — | 17.6 | 2.29 | acetate, | n.m. |
| | micro- | alkaline | 2 wt % | KOH | 24 h | | | | formate, | |
| | fibers | (2M KOH, | (1.6 mg | | | | | | glycolate, | |
| | (5 mg | 40° C.), | mL⁻¹) | | | | | | glyoxal | |
| | mL⁻¹) | with | | | | | | | | |
| | | stirring | | | | | | | | |
| 7 | PCL | Enzyme | TiO₂\|Pt- | Carbonate | AM 1.5 G | 2.9 ± | 29300 ± | 61.1 ± | pentanal, | traces |
| | nano- | treatment 1 | 1 wt % | buffer | 24 h | 0.4 | 3700 | 7.7 | formate, | |
| | plastics | (Dura) | (2 mg | (pH 6) | | | | | CO₂, | |
| | (~0.1 mg | | mL⁻¹) | | | | | | | |
| | mL⁻¹) | | | | | | | | | |
| 8 | PCL | Enzyme | TiO₂\|Pt- | Carbonate | AM 1.5 G | 2.9 ± | 29400 ± | 61.2 ± | pentanal, | traces |
| | nano- | treatment 2 | 1 wt % | buffer | 24 h | 0.2 | 2200 | 4.6 | formate, | |
| | plastics | (LCC) | (2 mg | (pH 6) | | | | | CO₂, | |
| | (~0.1 mg | | mL⁻¹) | | | | | | | |
| | mL⁻¹) | | | | | | | | | |
| 9 | PCL | Enzyme | CNₓ\|Ni₂P- | Carbonate | AM 1.5 G | 0.03 ± | 275 ± | 0.6 ± | n.q. | n.q. |
| | nano- | treatment 1 | 2 wt % | buffer | 24 h | 0.002 | 24 | 0.04 | | |
| | plastics | (Dura) | (2 mg | (pH 6) | | | | | | |
| | (~0.1 mg | | mL⁻¹) | | | | | | | |
| | mL⁻¹) | | | | | | | | | |
| 10 | PCL | Enzyme | CNₓ\|Ni₂P- | Carbonate | AM 1.5 G | 0.02 ± | 220. ± | 0.5 ± | n.q. | n.q. |
| | nano- | treatment 2 | 2 wt % | buffer | 24 h | 0.003 | 34 | 0.1 | | |
| | plastics | (LCC) | (2 mg | (pH 6) | | | | | | |
| | (~0.1 mg | | mL⁻¹) | | | | | | | |
| | mL⁻¹) | | | | | | | | | |
| 11 | PET | Enzyme | TiO₂\|Pt- | Carbonate | AM 1.5 G | 3.5 ± | 24900 ± | 72.8 ± | formate | traces |
| | nano- | treatment 1 | 1 wt % | buffer | 24 h | 0.6 | 4070 | 11.9 | | |
| | plastics | (Dura) | (2 mg | (pH 6) | | | | | | |
| | (~0.1 mg | | mL⁻¹) | | | | | | | |
| | mL⁻¹) | | | | | | | | | |
| 12 | PET | Enzyme | TiO₂\|Pt- | Carbonate | AM 1.5 G | 3.8 ± | 27200 ± | 79.3 ± | formate | traces |
| | nano- | treatment 2 | 1 wt % | buffer | 24 h | 0.3 | 2300 | 6.7 | | |
| | plastics | (LCC) | (2 mg | (pH 6) | | | | | | |
| | (~0.1 mg | | mL⁻¹) | | | | | | | |
| | mL⁻¹) | | | | | | | | | |
| 13 | PET | Enzyme | CNₓ\|Ni₂P- | Carbonate | AM 1.5 G | 0.1 ± | 392 ± | 1.1 ± | n.q. | n.q. |
| | nano- | treatment 2 | 2 wt % | buffer | 24 h | 0.05 | 130 | 0.3 | | |
| | plastics | (LCC) | (2 mg | (pH 6) | | | | | | |
| | (~0.1 mg | | mL⁻¹) | | | | | | | |
| | mL⁻¹) | | | | | | | | | |

TABLE 3

| | | | | | | | | Activity | | |
|---|---|---|---|---|---|---|---|---|---|---|
| | | Pre- | | | | | Yield | (μmol | Oxidation | |
| | | treatment | Photo- | | Irradi- | n[H₂] | (μmol | g_{cat}⁻¹ | products | n[OP] |
| No. | Substrate | conditions | catalyst | Media | ation | (μmol) | g_{sub}⁻¹) | h⁻¹) | (OP) | (μmol) |
| 6 | PET | Enzyme | TiO₂\|Pt- | Carbonate | AM 1.5 G | 24.8 ± | 1240 ± | 518 ± | formate, | 3.3 ± |
| | film | treatment 2 | 1 wt % | buffer | 24 h | 0.6 | 31 | 13 | glycolate, | 0.2, |
| | (20 mg | (LCC) | (2 mg | (pH 6) | | | | | oxalate | n.q., n.q., |
| | mL⁻¹) | | mL⁻¹) | | | | | | | resp. |
| C5 | | LCC | TiO₂\|Pt- | Carbonate | AM 1.5 G | 2.5 ± | — | 51.3 ± | — | — |
| | | | 1 wt % | buffer | 24 h | 0.2 | | 4.3 | | |
| | | | (2 mg | (pH 6) | | | | | | |
| | | | mL⁻¹) | | | | | | | |
| C6 | PET | | TiO₂\|Pt- | Carbonate | AM 1.5 G | 0.7 ± | 34.9 ± | 14.5 ± | — | — |
| | film | | 1 wt % | buffer | 24 h | 0.4 | 18.0 | 7.5 | | |
| | (20 mg | | (2 mg | (pH 6) | | | | | | |
| | mL⁻¹) | | mL⁻¹) | | | | | | | |
| C7 | PET | Enzyme | TiO₂ | Carbonate | AM 1.5 G | 0.2 ± | 10.8 ± | 4.5 ± | — | — |
| | film | treatment 2 | (2 mg | buffer | 24 h | 0.01 | 0.8 | 0.3 | | |
| | (20 mg | (LCC) | mL⁻¹) | (pH 6) | | | | | | |
| | mL⁻¹) | | | | | | | | | |

TABLE 4

| | | | | | | Activity | | | Activity | | | | |
|---|---|---|---|---|---|---|---|---|---|---|---|---|---|
| | | Sub- | | | Yield | [H₂] ± σ | | Yield | [H₂] ± σ | | | | |
| | | strate/ | | | [CO] ± σ | (μmol | | [H₂] ± σ | (μmol | | | | |
| | Photo- | Treat- | Time | n[CO] ± σ | (μmol | g_{cat}⁻¹ | n[H₂] ± σ | (μmol | g_{cat}⁻¹ | TON | TON | | n[OP] ± σ |
| No. | catalyst | ment | (h) | (μmol) | g_{sub}⁻¹) | h⁻¹) | (μmol) | g_{sub}⁻¹) | h⁻¹) | [CO] | [H₂] | OP | (μmol) |
| 14 | TiO₂\| | pre- | 24 | 0.17 ± | 8.5 ± | 1.4 ± | 1.63 ± | 81.5 ± | 13.6 ± | 3 | 33 | for- | n.q |
| | CotpyP- | treated | | 0.04 | 2 | 0.3 | 0.30 | 15 | 2.5 | | | mate | |
| | 10 nmol | PET | 48 | 0.42 ± | 21 ± | 1.8 ± | 3.53 ± | 177 ± | 14.7 ± | 8 | 71 | | |
| | mg_{TiO2}⁻¹ | film | | 0.09 | 5 | 0.4 | 0.68 | 34 | 2.8 | | | | |
| | (1.67 mg | (6.67 mg | | | | | | | | | | | |
| | mL⁻¹) | mL⁻¹) | | | | | | | | | | | |
| | | [before | | | | | | | | | | | |
| | | TPA | | | | | | | | | | | |
| | | removal + | | | | | | | | | | | |
| | | neutral- | | | | | | | | | | | |
| | | ization] | | | | | | | | | | | |
| 15 | TiO₂\| | pre- | 24 | 0.81 ± | 40.5 ± | 6.8 ± | 3.58 ± | 179 ± | 29.8 ± | 16 | 72 | for- | n.q. |
| | CotpyP- | treated | | 0.06 | 3 | 0.5 | 0.19 | 9.5 | 1.6 | | | mate | |
| | 10 nmol | PET | 48 | 1.59 ± | 79.5 ± | 6.6 ± | 6.75 ± | 338 ± | 28.1 ± | 32 | 135 | | |
| | mg_{TiO2}⁻¹ | film | | 0.12 | 6 | 0.5 | 0.34 | 17 | 1.4 | | | | |
| | (1.67 mg | (6.67 mg | | | | | | | | | | | |
| | mL⁻¹) | mL⁻¹) | | | | | | | | | | | |
| | | [after | | | | | | | | | | | |
| | | TPA | | | | | | | | | | | |
| | | removal + | | | | | | | | | | | |
| | | neutral- | | | | | | | | | | | |
| | | ization] | | | | | | | | | | | |
| 16 | TiO₂\| | pre- | 24 | 0.73 ± | 36.5 ± | 6.1 ± | 3.13 ± | 156.5 ± | 26.1 ± | 29 | 125 | for- | n.q. |
| | CotpyP- | treated | | 0.01 | 0.5 | 0.1 | 0.13 | 7 | 1.1 | | | mate | |
| | 5 nmol | PET | 48 | 1.39 ± | 69.5 ± | 5.8 ± | 5.56 ± | 278 ± | 23.2 ± | 56 | 222 | | |
| | mg_{TiO2}⁻¹ | film | | 0.02 | 1 | 0.1 | 0.27 | 13.5 | 1.1 | | | | |
| | (1.67 mg | (6.67 mg | | | | | | | | | | | |
| | mL⁻¹) | mL⁻¹) | | | | | | | | | | | |
| | | [after | | | | | | | | | | | |
| | | TPA | | | | | | | | | | | |
| | | removal + | | | | | | | | | | | |
| | | neutral- | | | | | | | | | | | |
| | | ization] | | | | | | | | | | | |

TABLE 5

| | | | | Aerial | | |
|---|---|---|---|---|---|---|
| | | | | efficiency | | |
| | | | | [H₂] | | |
| | | Time | n[H₂] | (μmol | | n[OP] |
| No | System | (h) | (μmol) | mᵢᵣᵣ⁻¹) | OP | (μmol) |
| 17 | PET | 2 | 0.05 | 40.0 | | |
| | film + | 4 | 0.09 | 75.7 | | |
| | LCC | 24 | 1.6 | 1280 | | |
| | enzyme | 48 | 3.6 | 2940 | | |
| | | 72 | 11.3 | 9230 | | |
| | | 96 | 11.9 | 9780 | formate, | 4.9, n.q., |
| | | | | | glycolate, | n.q., resp. |
| | | | | | oxalate | |
| | blank | 2 | 0.07 | 58.2 | | |
| | buffer | 4 | 0.1 | 102 | | |
| | | 24 | 0.15 | 126 | | |
| | | 48 | 0.18 | 152 | | |
| | | 72 | 0.25 | 203 | | |
| | | 96 | 0.3 | 243 | — | — |

1. A method for upcycling plastic waste comprising:
(i) contacting a plastic from said plastic waste with an enzyme to degrade said plastic to provide a composition comprising monomers and/or oligomers, and/or derivatives therefrom, of said plastic; and
(ii) photoreforming said composition to produce a mixture of products comprising hydrogen gas and oxidation products of said monomers and/or oligomers, and/or derivatives therefrom.

2. A method as claimed in claim 1, wherein said plastic is in the form of film, fiber, powder, pellets, microparticles, nanoparticles, or a combination thereof.

3. (canceled)

4. A method as claimed in claim 3, wherein said polyester is selected from poly(ethylene terephthalate) (PET), poly(butylene terephthalate) (PBT), polyethylene naphthalene (PEN), polytrimethylene terephthalate (PTT), polycaprolactone (PCL), polylactic acid (PLA), polyhydroxybutyrate (PHB), polyglycolic acid (PGA), polyethylene adipate (PEA), or a combination thereof.

5. A method as claimed in claim 1, wherein said enzyme is selected from depolymerases, laccases, esterases (such as cutinases, caboxylesterases, PETases), peroixdases, alkane hydroxylases, amidases, polyurethanases, peptidases, tannases, lignolytic enzymes, exopolysaccharide-degrading enzymes, or a combination thereof.

6. (canceled)

7. A method as claimed in claim 5, wherein said enzyme is selected from native sequences IsPETase (A0A0K8P6T7), Mono(2-hydroxyethyl) terephthalate hydrolase (A0A0K8P8E7), leaf-branch compost cutinase (LCC, G9BY57), Thermobifida fusca cutinase (TfCut, E5BBQ3_THEFU), Thermobifida fusca hydrolase (TfH, Q6A014), NylA (NYLA_PSES8) and NylB from strain NK87, Est1 from T.alba AHK119 (D4Q9N1); and their variants with sequence identity greater than 75%.

8. (canceled)

9. A method as claimed in claim 1, wherein said composition comprises monomers of said plastic and wherein said monomers are selected from 6-hydroxyhexanoic acid, ethylene glycol, methyenedianiline, bis(2-hydroxyethyl) terephthalate (BHET), mono (2-hydroxyethyl) terephthalate (MHET), 4-hydroxybutanoic acid, terephthalic acid, 1,4-butanediol, naphthalene-2,6-dicarboxylic acid, 1,3-propanediol, lactic acid, 2-hydroxybutanoic acid, 3-hydroxylbutanoic acid, glycolic acid, adipic acid and/or derivatives thereof, or a combination thereof.

10. A method as claimed in claim 1, wherein said composition further comprises CO₂.

11. A method as claimed in claim 10, wherein CO₂ is added to said composition prior to step (ii).

12. (canceled)

13. A method as claimed in claim 1, wherein said photoreforming is carried out with visible light.

14. A method as claimed in claim 1, wherein said photoreforming is carried out with a photocatalyst comprising a photoactive material selected from metal oxide, a chalcogenide, a nitride, a carbon-based photosensitiser, dyes, nanoparticles (such as quantum dots), a pervoskite, a metal-organic framework, a covalent-organic framework or a co-ordination polymer, or a combination thereof.

15. A method as claimed in claim 1, wherein said photoreforming is carried out with a photocatalyst comprising a photoactive material selected from TiO₂, SrTiO₃, Fe₂O₃, SnO₂, ZrO₂, W₃, ZnO, CdS, CdSe, ZnS, ZnSe, CdTe, MoS₂ GaN, InN, carbon-nitride, carbon cots, graphene, a molecular dye, CsPbCl₃, CsPbBr₃, CsPbl₃, Cs₃Bi₂Cl₉, Cs₃Bi₂Br₉, or Cs₃Bi₂I₉, or a combination thereof.

16. A method as claimed in claim 1, wherein said photoreforming is carried out with a photocatalyst comprising both a photoactive material and a co-catalyst.

17. A method as claimed in claim 16, wherein the co-catalyst comprises a hydrogen evolution catalyst and Pt, Pd, Ru, Ni, Co, Fe, Mn, Cu, Zn, or a combination thereof.

18. A method as claimed in claim 16, wherein the co-catalyst comprises Pt, Ni2P, hydrogenase, phosphonated Re complexes, [Re(2,2′-bipyridine-4,4′-bisphosphonic acid)(CO)₃(L)] where L=3-picoline or bromide, carbon monoxide dehydrogenase, or formate dehydrogenase.

19. A method as claimed in claim 16, wherein the co-catalyst is capable of reducing carbon dioxide.

20. (canceled)

21. A method as claimed in claim 1, wherein said oxidation products of said monomers and/or oligomers, and/or derivatives therefrom, are selected from formic acid, glycolic acid, oxalic acid, acetic acid, glyoxal, glycolaldehyde, pentanal, hexanal, butanal, propanal, ethanal, carbon dioxide, derivatives therefrom, and/or a combination thereof.

22. A method as claimed in claim 1, wherein steps (i) and (ii) are carried out concurrently in a single reactor.

23. A method for upcycling plastic waste comprising:
(i) contacting a plastic from said plastic waste with an enzyme to degrade said plastic to provide a composition comprising monomers and/or oligomers, and/or derivatives therefrom of said plastic and CO₂;
(ii) photoreforming said composition to produce a mixture of products comprising hydrogen gas, CO and oxidation products of said monomers and/or oligomers, and/or derivatives therefrom.

24. A system for upcycling plastic waste comprising:
(i) a degradation reactor for contacting a plastic from said plastic waste with an enzyme to degrade said plastic to provide a composition comprising monomers and/or oligomers, and/or derivatives therefrom, of said plastic;
(ii) a photoreactor comprising a photocatalyst for photoreforming said composition to produce a mixture of products comprising hydrogen gas and oxidation products of said monomers and/or oligomers, and/or derivatives therefrom, and
(iii) a means for transporting the composition comprising monomers and/or oligomers, and/or derivatives therefrom, of said plastic to said comprising a photocatalyst and/or photoreactor for photoreforming.

25. A system as claimed in claim 24, wherein said degradation reactor and said photoreactor are integrated.
